(19) United States
(12) Patent Application Publication
(10) Pub. No.: US 2011/0284501 A1
(43) Pub. Date: Nov. 24, 2011

(54) WELDING SYSTEM

(75) Inventors: Pei-Chung Wang, Pudong (CN); Zhongqin Lin, Shanghai (CN); Xinmin Lai, Shanghai (CN); Yansong Zhang, Shanghai (CN)

(73) Assignee: GM GLOBAL TECHNOLOGY OPERATIONS LLC, Detroit, MI (US)

(21) Appl. No.: 13/039,343

(22) Filed: Mar. 3, 2011

(30) Foreign Application Priority Data
May 21, 2010 (CN) 201010182011.8

(51) Int. Cl. B23K 11/00

(52) U.S. Cl. 219/78.01

(57) ABSTRACT

A welding system includes a first electrode, a first metal substrate having a first melting point temperature, and a second metal substrate having a second melting point temperature and disposed adjacent and in contact with the first metal substrate to define a faying interface therebetween. The welding system also includes a second electrode spaced apart from the first electrode and disposed in electrically-conductive relationship with the second metal substrate. Further, the welding system includes a flexible strip disposed between and in electrically-conductive relationship with each of the first electrode and the first metal substrate. The flexible strip is formed from an electrically-conductive material and has a melting point temperature that is greater than or equal to each of the first melting point temperature and the second melting point temperature.

### CROSS-REFERENCE TO RELATED APPLICATIONS

This application claims the benefit of Chinese Patent Application No. 201010182011.8, filed May 21, 2010, which is hereby incorporated by reference in its entirety.

### TECHNICAL FIELD

The present disclosure generally relates to a welding system.

### BACKGROUND

Welding may be used to join two or more metal substrates. In general, welding may include clamping a workpiece, e.g., the two or more metal substrates to be joined, between two electrodes with a force, and passing an electrical current from one electrode, through the workpiece, to the second electrode for a duration to thereby complete an electrical circuit. The electrical current causes sufficient heat due to electrical resistance to build up at a faying interface between the metal substrates so as to partially and momentarily melt the faying interface and form a weld nugget, i.e., a weld. The aforementioned heat build-up may also cause an incremental rise in temperature of each electrode as heat is dissipated away from the workpiece during welding and cooling cycles.

Since each electrode is subjected to both force and electrical current during welding, each electrode may experience thermal and mechanical excursions which increase in severity as a thickness of the workpiece decreases. Therefore, after a few welding cycles of thin-gage metal substrates, the electrodes may change shape. Such change in shape may decrease the clamping ability of the electrodes and/or the electrical current density transmittable through the electrodes. And, in turn, such decreases may necessitate early replacement and/or redressing, e.g., grinding, of the electrodes.

### SUMMARY

A welding system includes a first electrode, a first metal substrate having a first melting point temperature, and a second metal substrate having a second melting point temperature. The second metal substrate is disposed adjacent and in contact with the first metal substrate to define a faying surface therebetween. The welding system further includes a second electrode spaced apart from the first electrode and disposed in electrically-conductive relationship with the second metal substrate. Additionally, the welding system includes a flexible strip disposed between and in electrically-conductive relationship with each of the first electrode and the first metal substrate, wherein the flexible strip is formed from an electrically-conductive material and has a melting point temperature that is greater than or equal to each of the first melting point temperature and the second melting point temperature.

The welding system maximizes an operating life of each of the first electrode and second electrode. That is, the flexible strip both allows heat to build up at the faying interface between the first metal substrate and the second metal substrate, and shields each of the first electrode and the second electrode from excessive heat so as to minimize electrode degradation. Therefore, the welding system also minimizes electrode replacement and redressing. Further, the welding system minimizes an amount of electrical current required to form a desired size of a weld, and results in welds having excellent appearance and weld strength. As such, the welding system minimizes in-process inspection and/or time-consuming repair of discrepant welds due to electrode deformation, and prolongs electrode operating life for applications requiring welds formed between, for example, thin-gage and thick-gage metal substrates.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic cross-sectional view of a welding system including two metal substrates disposed between two electrodes during formation of a weld, wherein a flexible strip is disposed between and in electrically-conductive relationship with each of a first electrode and a first metal substrate;

FIG. 2 is a schematic cross-sectional view of another variation of the welding system of FIG. 1 and includes an additional flexible strip disposed between and in contact with each of the first electrode and the flexible strip of FIG. 1; and

FIG. 3 is a schematic cross-sectional view of another variation of the welding system of FIG. 1 and includes the additional flexible strip disposed between and in contact with each of a second electrode and a second metal substrate.

### DETAILED DESCRIPTION

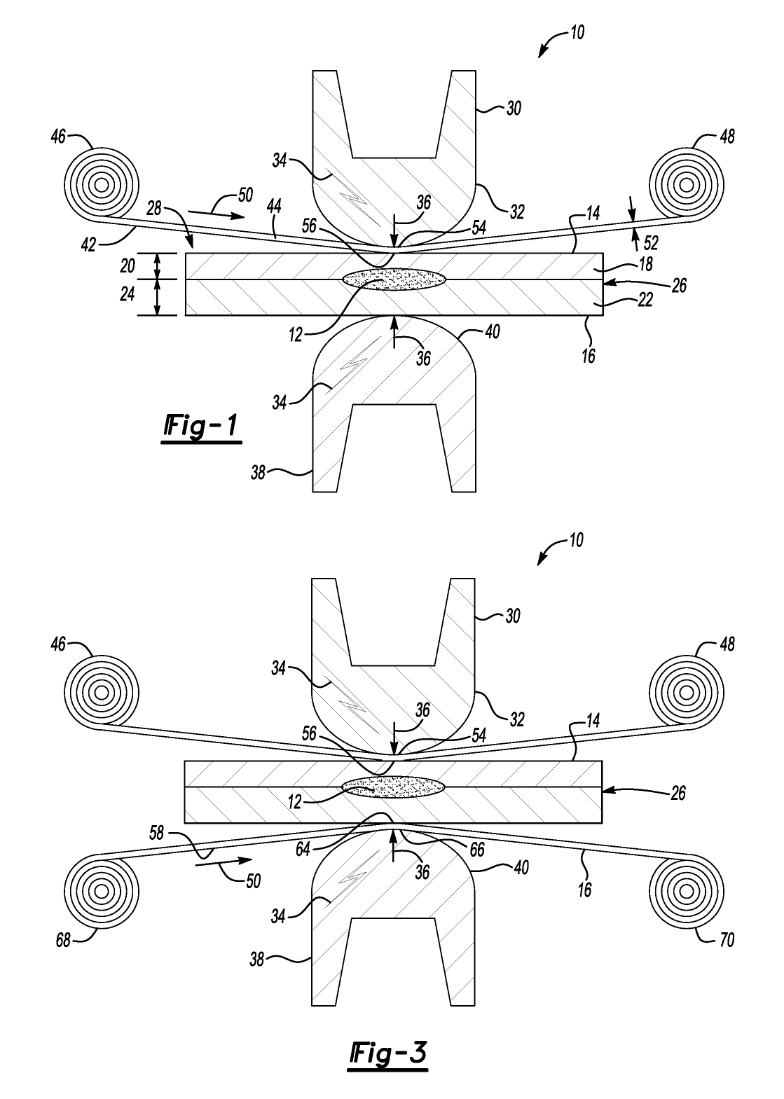

Referring to the Figures, wherein like reference numerals refer to like elements, a welding system is shown generally at 10 in FIG. 1. The welding system 10 may be useful for forming a weld, which is shown generally at 12 in FIG. 1, to thereby join two or more metal substrates 14, 16. For example, the welding system 10 may be useful for joining two or more metal substrates 14, 16 via resistance spot welding or weld-bonding, as set forth in more detail below. Therefore, the welding system 10 may be useful for applications such as, but not limited to, automotive applications requiring a strong weld 12.

Referring to FIG. 1, the welding system 10 includes a first metal substrate 14 having a first melting point temperature 18. The first metal substrate 14 may be any suitable metal. For example, the first metal substrate 14 may be selected from the group of steel and aluminum, including alloys thereof. As used herein, the terminology “first melting point temperature 18” refers to a temperature at which the first metal substrate 14 changes from a solid state to a liquid state, i.e., the temperature at which the first metal substrate 14 melts. Further, the first metal substrate 14 may have a first thickness 20. For example, the first thickness 20 of the first metal substrate 14 may be from about 0.2 mm to about 6 mm.

With continued reference to FIG. 1, the welding system 10 also includes a second metal substrate 16 having a second melting point temperature 22. The second metal substrate 16 may also be any suitable metal. For example, the second metal substrate 16 may be selected from the group of steel and aluminum, including alloys thereof. Further, the second metal substrate 16 may be formed from the same or different metal as the first metal substrate 14. That is, the welding system 10 may be useful for joining similar or dissimilar metals. Therefore, the second melting point temperature 22 may be the same or different than the first melting point temperature 18. As used herein, the terminology “second melting point temperature 22” refers to a temperature at which the second metal substrate 16 changes from a solid state to a liquid state, i.e., the temperature at which the second metal substrate 16 melts. Further, the second metal substrate 16 may have a second thickness 24. For example, the second thickness 24 of the second metal substrate 16 may be from about 0.2 mm to about 6 mm.

The second thickness 24 of the second metal substrate 16 may be greater than or equal to the first thickness 20. That is, referring to FIG. 1, the first metal substrate 14 may be thinner than the second metal substrate 16. Further, a ratio of the first thickness 20 to the second thickness 24 may be greater than or equal to about 1:2. For example, the first metal substrate 14 may have a first thickness 20 of about 0.7 mm and the second metal substrate 16 may have a second thickness 24 of about 2 mm. Therefore, the welding system 10 of FIG. 1 may be useful for joining a comparatively thinner metal substrate to a thicker metal substrate to form, for example, a thin-thick joint.

As shown in FIG. 1, the second metal substrate 16 is disposed adjacent and in contact with the first metal substrate 14 to define a faying interface 26 therebetween. That is, the first metal substrate 14 and the second metal substrate 16 may be sandwiched together to form a workpiece 28. As used herein, the terminology “faying interface 26” refers to a contact point between the first metal substrate 14 and the second metal substrate 16 that momentarily melts, e.g., at temperatures higher than each of the first melting point temperature 18 and the second melting point temperature 22, to thereby form the weld 12, as set forth in more detail below.

With continued reference to FIG. 1, the welding system 10 further includes a first electrode 30. The first electrode 30 may be spaced apart from the first metal substrate 14 and may be moveable with respect to the first metal substrate 14. That is, the first electrode 30 may be connected to an arm (not shown) or other element configured for positioning the first electrode 30 near the first metal substrate 14. For example, the first electrode 30 may be a servomotor-driven moveable electrode 30.

In addition, the first electrode 30 may have a distal end 32 configured for both transmitting an electrical current, i.e., a weld current (designated by symbol 34 in FIG. 1) supplied by a power source (not shown), and applying a clamping force (designated by arrow 36 in FIG. 1) to the workpiece 28. Therefore, the first electrode 30 may be formed from any suitable electrically-conductive material, e.g., copper, and may have any suitable shape. For example, the first electrode 30 may be classified as a B-nose or A-nose electrode.

Referring again to FIG. 1, the welding system 10 also includes a second electrode 38 spaced apart from the first electrode 30 and disposed in electrically-conductive relationship with the second metal substrate 16. That is, the second electrode 38 may be spaced apart from the first electrode 30 so as to allow placement of the workpiece 28 between each of the first electrode 30 and the second electrode 38 so that the second electrode 38 may conduct the weld current 34 to the second metal substrate 16. For example, the second electrode 38 may be disposed adjacent and in contact with the second metal substrate 16. Further, the second electrode 38 may also be fixed or moveable with respect to the second metal substrate 16 and may be connected to an arm (not shown) or other element configured for positioning the second electrode 38 adjacent and in contact with the second metal substrate 16. For example, the second electrode 38 may be a servomotor-driven moveable electrode 38.

And, referring to FIG. 1, the second electrode 38 may have a distal end 40 configured for both transmitting the electrical current, i.e., the weld current 34, and applying the clamping force 36 to the workpiece 28. Therefore, the second electrode 38 may also be formed from any suitable electrically-conductive material, e.g., copper. Further, the second electrode 38 may be any suitable electrode and may have a shape similar to or different from the first electrode 30. That is, although shown in FIG. 1 as having a similar shape as the first electrode 30, the second electrode 38 may have a different shape than the first electrode 30 and may be classified as a B-nose or A-nose electrode.

Referring again to FIG. 1, the welding system 10 also includes a flexible strip 42 disposed between and in electrically-conductive relationship with each of the first electrode 30 and the first metal substrate 14. That is, the flexible strip 42 may be disposed in relationship with each of the first electrode 30 and the first metal substrate 14 so as to conduct the weld current 34 between the first electrode 30 and the first metal substrate 14. For example, the flexible strip 42 may be sandwiched between, and contact each of the first electrode 30 and the first metal substrate 14.

The flexible strip 42 is formed from an electrically-conductive material and has a melting point temperature 44 that is greater than or equal to each of the first melting point temperature 18 and the second melting point temperature 22. That is, the flexible strip 42 may be formed from any suitable material that does not impede, i.e., insulate, the flow of the weld current 34 between the first electrode 30 and the first metal substrate 14. By way of non-limiting examples, the flexible strip 42 may be formed from a material selected from the group including copper, aluminum, steel, silver, gold, and titanium, including alloys and combinations thereof. And, since the melting point temperature 44 of the flexible strip 42 is greater than or equal to each of the first melting point temperature 18 of the first metal substrate 14 and the second melting point temperature 22 of the second metal substrate 16, the flexible strip 42 does not melt before each of the first metal substrate 14 and the second metal substrate 16 melts. Therefore, the flexible strip 42 may conduct the weld current 34 from the first electrode 30 to the first metal substrate 14 without melting to thereby promote momentary melting at the faying interface 26 between the first metal substrate 14 and the second metal substrate 16.

The flexible strip 42 may be pliable, i.e., not rigid, so as to be positionable between and in electrically-conductive relationship with, e.g., contact with, each of the first electrode 30 and the first metal substrate 14. That is, the flexible strip 42 may be disposed in contact with the comparatively thinner first metal substrate 14 as set forth above. In one variation, the flexible strip 42 may be linearly translatable along the first electrode 30. That is, as shown schematically in FIG. 1, the flexible strip 42 may be a ribbon, e.g., a tape or a foil, which is wound around a plurality of spools 46, 48. In operation, the flexible strip 42 may be unwound from a first spool 46, linearly translate along the distal end 32 of the first electrode 30 in the direction of arrow 50 in FIG. 1, and then rewind onto a second spool 48. Therefore, the flexible strip 42 may be translated as necessary for refreshed contact with each of the first electrode 30 and the first metal substrate 14.

As shown in FIG. 1, the flexible strip 42 may have a thickness 52 of less than the first thickness 20 of the first metal substrate 14. For example, the flexible strip 42 may have a thickness 52 of from about 0.1 mm to about 0.4 mm. In one variation, for applications including the first metal substrate 14 that is thinner than the second metal substrate 16, the flexible strip 42 may have a thickness 52 of about 0.2 mm.

As shown in FIG. 1, the welding system 10 may also include the weld 12 disposed at the faying interface 26 whereby the first metal substrate 14 and the second metal substrate 16 are joined. That is, the weld 12 may form due to heat build-up from resistance to the weld current 34 in each of the first metal substrate 14 and the second metal substrate 16. As the faying interface 26 momentarily melts from the heat build-up, the weld 12 may form so as to join the first metal substrate 14 and the second metal substrate 16. By way of non-limiting examples, the weld 12 may be a resistance spot weld 12 or a weld-bonded weld 12.

Without intending to be limited by theory, and described with reference to FIG. 1, the flexible strip 42 may provide two additional faying interfaces 54, 56 for the welding system 10. More specifically, in addition to the faying interface 26 between the first metal substrate 14 and the second metal substrate 16, the flexible strip 42 may provide two additional faying interfaces 54, 56 between the first electrode 30 and the first metal substrate 14. Since electrical resistance is high at each faying interface 26, 54, 56, the weld current 34 flowing from the first electrode 30 to the flexible strip 42, through the flexible strip 42 to the first metal substrate 14, and through the first metal substrate 14 to the second metal substrate 16, causes temperature to rise at each faying interface 26, 54, 56 of the welding system 10. When the temperature reaches the first melting point temperature 18 and the second melting point temperature 22, the faying interface 26 between the first metal substrate 14 and the second metal substrate 16 momentarily melts so as to form the weld 12. And, since the melting point temperature 44 of the flexible strip 42 is greater than or equal to each of the first melting point temperature 18 and the second melting point temperature 22, heat dissipation at the faying interface 26 between the first metal substrate 14 and the second metal substrate 16 is shielded by the flexible strip 42. Consequently, the temperature at the faying interface 26 between the first metal substrate 14 and the second metal substrate 16 may rise relatively quickly as compared to the temperature of the additional faying interfaces 54, 56 between the first electrode 30 and the first metal substrate 14 provided by the flexible strip 42.

Therefore, for a given weld current 34, a size of the weld 12 formed by the welding system 10 including the flexible strip 42 may be larger than a size of a weld (not shown) formed without the presence of the flexible strip 42. As a result, the weld current 34 to the welding system 10 may be reduced without affecting the desired size and/or weld strength of the weld 12. Additionally, a reduction in weld current 34 may lower a temperature of the first electrode 30 and consequently maximize the working life of the first electrode 30. That is, the first electrode 30 may not thermally- and/or mechanically-degrade as readily. Therefore, the first electrode 30 may not require frequent redressing, e.g., grinding, to maintain a desired shape of the first electrode 30 and/or minimize distortions of the shape of the first electrode 30, e.g., mushrooming. Therefore, the welding system 10 may be particularly useful for joining a relatively thin first metal substrate 14 and a relatively thick second metal substrate 16.

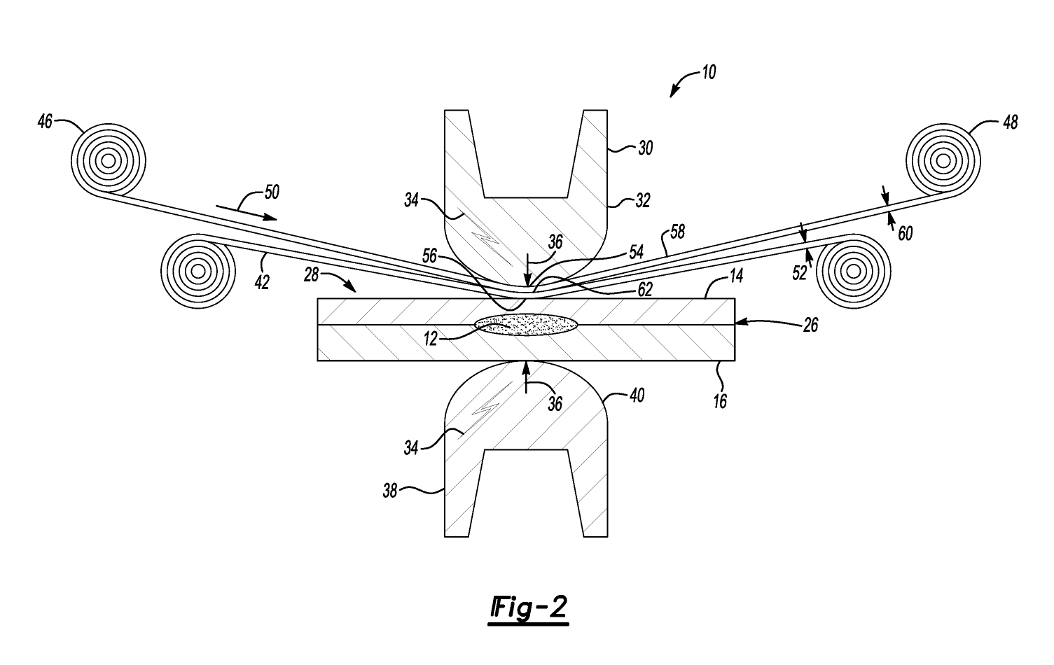

Referring now to FIG. 2, in another variation, the welding system 10 may further include an additional flexible strip 58. The additional flexible strip 58 may be formed from the same or different material than the flexible strip 42 set forth above. That is, the additional flexible strip 58 may be formed from materials such as, steel or titanium, including alloys thereof. Further, the additional flexible strip 58 may have the same or different thickness 60 that the thickness 52 of the flexible strip 42 set forth above. For example, the thickness 60 of the additional flexible strip 58 may be from about 0.1 to about 0.4 mm.

As shown in FIG. 2, the additional flexible strip 58 may be disposed between and in contact with each of the first electrode 30 and the flexible strip 42. That is, the additional flexible strip 58 may be sandwiched between the first electrode 30 and the flexible strip 42 so as to provide an additional electrically-conductive layer and another faying interface 62 between the first electrode 30 and the first metal substrate 14. The additional flexible strip 58 may also be pliable so as to linearly translatable along the first electrode 30. That is, the additional flexible strip 58 may also be a ribbon, e.g., a tape or a foil that is wound around the plurality of spools 46, 48. In operation, the additional flexible strip 58 may be unwound from the first spool 46, linearly translate along the distal end 32 of the first electrode 30 in the direction of arrow 50 in FIG. 2, and then rewind onto the second spool 48. Therefore, the additional flexible strip 58 may translate as necessary for refreshed contact with each of the first electrode 30 and the flexible strip 42.

In another variation described with reference to FIG. 3, the additional flexible strip 58 may be disposed between and in contact with each of the second electrode 38 and the second metal substrate 16. That is, the additional flexible strip 58 may be sandwiched between the second electrode 38 and the second metal substrate 16 so as to provide an additional electrically-conductive layer and two other faying interfaces 64, 66 between the second electrode 38 and the second metal substrate 16. And, although the additional flexible strip 58 may contact the second electrode 38 via any suitable manner, in one example, the additional flexible strip 58 may be wound around a second plurality of spools 68, 70. More specifically, the additional flexible strip 58 may be unwound from a third spool 68, linearly translate along the distal end 40 of the second electrode 38 in the direction of arrow 50 in FIG. 3, and then rewind onto a fourth spool 70. Therefore, the additional flexible strip 58 may translate as necessary for refreshed contact with each of the second electrode 38 and the second metal substrate 16.

Further, although not shown, the welding system 10 may include any number of additional flexible strips 58. For example, although not shown, one additional flexible strip 58 may be disposed between the first electrode 30 and the flexible strip 42, while one additional flexible strip 58 may be disposed between the second electrode 38 and the second metal substrate 16. Alternatively, although not shown, one additional flexible strip 58 may be disposed between the first electrode 30 and the flexible strip 42, while two additional flexible strips 58 may be layered between the second electrode 38 and the second metal substrate 16.

Without intending to be limited by theory, and described with reference to FIGS. 2 and 3, the additional flexible strip 58 may also increase the number of faying interfaces 26, 54, 56, 62 (FIG. 2), 64, 66 (FIG. 3) for the welding system 10. That is, in addition to the faying interface 26 between the first metal substrate 14 and the second metal substrate 16, the additional flexible strip 58 may provide another faying interface 62 (FIG. 2) between the first electrode 30 and the flexible strip 42 and/or between the second electrode 38 and the second metal substrate 16, e.g., faying interfaces 64, 66 in FIG. 3.

For example, referring to FIG. 2, since electrical resistance is high at each faying interface 54, 62, 56, the weld current 34 flowing from the first electrode 30 to the additional flexible strip 58, through the additional flexible strip 58 to the flexible strip 42, through the flexible strip 42 to the first metal substrate 14, and through the first metal substrate 14 to the second metal substrate 16, causes temperature to rise at each faying interface 54, 62, 56, 26 of the welding system 10. Likewise, described with reference to FIG. 3, since electrical resistance is high at each faying interface 54, 56, 26, 64, 66, the weld current 34 flowing from the first electrode 30 to the flexible strip 42, through the flexible strip 42 to the first metal substrate 14, through the first metal substrate 14 to the second metal substrate 16, through the second metal substrate 16 to the additional flexible strip 58, and through the additional flexible strip 58 to the second electrode 38 causes the temperature to rise at each faying interface 54, 56, 26, 64, 66 of the welding system 10.

When the temperature reaches the first melting point temperature 18 and the second melting point temperature 22, the faying interface 26 between the first metal substrate 14 and the second metal substrate 16 momentarily melts so as to form the weld 12. And, since the melting point temperature 44 (FIG. 1) of each of the flexible strip 42 and one or more additional flexible strips 58 is greater than or equal to each of the first melting point temperature 18 (FIG. 1) of the first metal substrate 14 and the second melting point temperature 22 (FIG. 1) of the second metal substrate 16, heat dissipation at the faying interface 26 between the first metal substrate 14 and the second metal substrate 16 is shielded by the flexible strip 42 and the one or more additional flexible strips 58. Consequently, the temperature at the faying interface 26 between the first metal substrate 14 and the second metal substrate 16 may rise relatively quickly as compared to the temperature of the additional faying interfaces 54, 62, 56 (FIG. 2) between the first electrode 30 and the first metal substrate 14 provided by the flexible strip 42, and the additional faying interfaces 64, 66 (FIG. 3) between the second electrode 38 and the second metal substrate 16 provided by the one or more additional flexible strips 58.

Therefore, for a given weld current 34, a size of the weld 12 formed by the welding system 10 including the flexible strip 42 and the additional flexible strip 58 may be larger than a size of a weld (not shown) formed without the presence of the flexible strip 42 and additional flexible strip 58. As a result, the weld current 34 may be reduced without affecting the desired size and/or weld strength of the weld 12. Additionally, a reduction in weld current 34 may lower a temperature of each of the first electrode 30 and the second electrode 38 and consequently maximize the working life of the first and second electrodes 30, 38. That is, each of the first electrode 30 and the second electrode 38 may not thermally- and/or mechanically-degrade as readily. Therefore, each of the first electrode 30 and the second electrode 38 may not require frequent redressing, e.g., grinding, to maintain a desired shape of the first electrode 30 and the second electrode 38 and/or minimize distortions of the shape of the first electrode 30 and the second electrode 38, e.g., mushrooming.

Therefore, with continued reference to FIGS. 1-3, a method of forming the weld 12 includes positioning the first metal substrate 14 adjacent and in contact with the second metal substrate 16 to define the faying interface 26 therebetween and form the workpiece 28. As set forth above, the first metal substrate 14 has the first melting point temperature 18 and the second metal substrate 16 has the second melting point temperature 22. And, in one variation, the first thickness 20 of the first metal substrate 14 may be less than the second thickness 24 of the second metal substrate 16.

The method further includes positioning the workpiece 28 between each of the first electrode 30 and the second electrode 38 so that the workpiece 28 is disposed in electrically-conductive relationship with each of the first electrode 30 and the second electrode 38. For example, the first metal substrate 14 may be disposed adjacent the first electrode 30 and the second metal substrate 16 may be disposed adjacent and in contact with the second electrode 38.

The method also includes disposing each of the first metal substrate 14 and the first electrode 30 in electrically-conductive relationship with the flexible strip 42 having the melting point temperature 44 that is greater than or equal to each of the first melting point temperature 18 and the second melting point temperature 22. For example, disposing may be further defined as contacting each of the first metal substrate 14 and the first electrode 30 with the flexible strip 42, as set forth above.

After disposing, the method includes supplying the electrical current, i.e., the weld current 34, through the first electrode 30 to melt the faying interface 26 and thereby form the weld 12. That is, since the melting point 44 of the flexible strip 42 is greater than or equal to each of the first melting point temperature 18 and the second melting point temperature 22, applying the electrical current, i.e., the weld current 34, through the first electrode 30 may melt the faying interface 26 without melting the flexible strip 42.

Additionally, as set forth above and described with reference to FIG. 2, the method may further include contacting each of the first electrode 30 and the flexible strip 42 with the additional flexible strip 58. Likewise, referring to FIG. 3, the method may further include contacting each of the second electrode 38 and the second metal substrate 16 with the additional flexible strip 58.

The welding system 10 maximizes an operating life of each of the first electrode 30 and second electrode 38. That is, the flexible strip 42 both allows heat to build up at the faying interface 26 between the first metal substrate 14 and the second metal substrate 16, and shields each of the first electrode 30 and the second electrode 38 from excessive heat so as to minimize electrode degradation. Therefore, the welding system 10 also minimizes electrode replacement and redressing. Further, the welding system 10 minimizes an amount of electrical weld current 34 required to form a desired size of a weld 12, and results in welds 12 having excellent appearance and weld strength. As such, the welding system 10 minimizes in-process inspection and/or time-consuming repair of discrepant welds due to electrode deformation, and prolongs electrode operating life for applications requiring welds 12 formed between, for example, thin-gage and thick-gage metal substrates 14, 16.

While the best modes for carrying out the disclosure have been described in detail, those familiar with the art to which this disclosure relates will recognize various alternative designs and embodiments for practicing the disclosure within the scope of the appended claims.

1. A welding system comprising:
a first electrode;
a first metal substrate having a first melting point temperature;
a second metal substrate having a second melting point temperature and disposed adjacent and in contact with said first metal substrate to define a faying interface therebetween;
a second electrode spaced apart from said first electrode and disposed in electrically-conductive relationship with said second metal substrate; and
a flexible strip disposed between and in electrically-conductive relationship with each of said first electrode and said first metal substrate, wherein said flexible strip is formed from an electrically-conductive material and has a melting point temperature that is greater than or equal to each of said first melting point temperature and said second melting point temperature.

2. The welding system of claim 1, wherein said flexible strip has a thickness of from about 0.1 mm to about 0.4 mm.

3. The welding system of claim 1, wherein said first metal substrate has a first thickness and said second metal substrate has a second thickness that is greater than or equal to said first thickness.

4. The welding system of claim 3, wherein said flexible strip has a thickness of about 0.2 mm.

5. The welding system of claim 3, wherein a ratio of said first thickness to said second thickness is greater than or equal to about 1:2.

6. The welding system of claim 1, wherein said flexible strip is linearly translatable along said first electrode.

7. The welding system of claim 1, further including an additional flexible strip.

8. The welding system of claim 7, wherein said additional flexible strip is disposed between and in contact with each of said second electrode and said second metal substrate.

9. The welding system of claim 7, wherein said additional flexible strip is disposed between and in contact with each of said first electrode and said flexible strip.

10. The welding system of claim 1, further including a weld disposed at said faying interface whereby said first metal substrate and said second metal substrate are joined.
